(19) United States
(12) Patent Application Publication
(10) Pub. No.: US 2021/0248532 A1
(43) Pub. Date: Aug. 12, 2021

(54) JOB INFORMATION PROVISION SYSTEM AND JOB INFORMATION PROVISION METHOD

(71) Applicant: HONDA MOTOR CO., LTD., Tokyo (JP)

(72) Inventors: Daisuke Sawai, Wako-shi (JP); Yoshiki Tatsutomi, Wako-shi (JP); Isao Uematsu, Wako-shi (JP); Takuya Miyashita, Wako-shi (JP)

(21) Appl. No.: 17/153,312

(22) Filed: Jan. 20, 2021

(30) Foreign Application Priority Data
Feb. 12, 2020 (JP) 2020-021409

(51) Int. Cl. G06Q 10/06; G06Q 10/02; G06Q 50/30; G06Q 30/06; G06Q 10/08; G06Q 30/02

(52) U.S. Cl. CPC G06Q 10/06313; G06Q 10/02; G06Q 50/30; G06Q 30/0208; G06Q 30/0645; G06Q 10/083; G06Q 10/063118

(57) ABSTRACT

A job information provision system includes: a user extraction section that extracts a user who meets a predetermined extraction condition; and a vehicle-based job information provision section that transmits, to a user terminal used by the user extracted by the user extraction section, first vehicle-based job information including a content of a first vehicle-based job to be carried out by using a shared vehicle.

### INCORPORATION BY REFERENCE

The present application claims priority under 35 U.S.C. § 119 to Japanese Patent Application No. 2020-021409 filed on Feb. 12, 2020. The content of the application is incorporated herein by reference in its entirety.

### BACKGROUND OF THE INVENTION

### Field of the Invention

The present invention relates to a job information provision system and a job information provision method.

### Description of the Related Art

Conventionally, a service management server has been known that operates and manages various services provided by using a shared vehicle (for example, see Japanese Patent Laid-Open No. 2019-79273).

The service management server provides a car sharing service of renting out a shared vehicle, a trunk sharing service of delivering luggage into a trunk of a shared vehicle, or the like. The service management server transmits, to a mobile terminal of a user of the shared vehicle, information for unlocking unlockable doors that are limited depending on a manner in which the shared vehicle is used.

While there has been an increasing number of services that use shared vehicles for various purposes in recent years as described in Japanese Patent Laid-Open No. 2019-79273, it is left to the discretion of a user to decide for what purpose the user uses a shared vehicle, and it can hardly be said that a shared vehicle is fully utilized.

The present invention has been made in view of such a background, and an object of the present invention is to provide a Job information provision system and a job information provision method that can promote utilization of a shared vehicle.

### SUMMARY OF THE INVENTION

A first aspect to achieve the above object is a job information provision system, including: a user extraction section that extracts a user who meets a predetermined extraction condition; and a vehicle-based job information provision section that transmits, to a user terminal used by the user extracted by the user extraction section, first vehicle-based job information including a content of a first vehicle-based job that is a job the user can carry out by using a shared vehicle.

In the job information provision system, the user extraction section may be configured to use, for the extraction condition, a fact that the user has made an application for reservation of the shared vehicle.

In the job information provision system, the vehicle-based job information provision section may be configured to transmit the first vehicle-based job information to the user terminal, by referring to a requested job database in which job request information including a requested content of each vehicle-based job to be carried out by using a vehicle is registered, and extracting, as the first vehicle-based job, a vehicle-based job with the requested content that meets a predetermined matching condition for matching with a content of the reservation of the shared vehicle specified by the application for reservation, among the vehicle-based jobs on which the job request information is registered in the requested job database.

In the job information provision system, the vehicle-based job information provision section may be configured to use, for the matching condition, a fact that a desired timing of carrying out the vehicle-based job specified by the job request information falls within any one of: a period of reservation of the shared vehicle specified by the application for reservation; a range between a first predetermined time period before a beginning time point of the period of reservation and the beginning time point; and a range between an ending time point of the period of reservation and a second predetermined time period after the ending time point.

In the job information provision system, the user extraction section may be configured to use, for the extraction condition, a fact that a point where the user is located is at or within a predetermined distance from a point where the shared vehicle is rented out.

In the job information provision system, when first vehicle-based job acceptance information for seeking to accept the first vehicle-based job is received from the user terminal, the vehicle-based job information provision section may be configured to transmit, to the user terminal, second vehicle-based job information including a content of a second vehicle-based job to be carried out by using the shared vehicle, the second vehicle-based job having a predetermined relation with the first vehicle-based job.

The job information provision system may be configured to further include a shared vehicle usage charge determination section that, when the user has carried out the first vehicle-based job, determines a usage charge for the shared vehicle to be claimed against the user, by making a discount off a basic usage charge for the shared vehicle, the discount being made according to an amount of a fee for the first vehicle-based job.

In the job information provision system, the first vehicle-based job may include delivery or collection, by using the shared vehicle, of vehicle-mountable moving means.

In the job information provision system, the first vehicle-based job may include agential delivery of a predetermined article from a provider to an orderer.

A second aspect to achieve the above object is a job information provision method executed by a computer, including: a user extraction step of extracting a user who meets a predetermined extraction condition; and a vehicle-based job information provision step of transmitting, to a user terminal used by the user extracted in the user extraction step, first vehicle-based job information including a content of a first vehicle-based job that is a job the user can carry out by using a shared vehicle.

According to the job information provision system, first vehicle-based job information including a content of a first vehicle-based job that is a job a user can carry out by using a shared vehicle is transmitted, by the vehicle-based job provision section, to a user terminal used by the user extracted by the user extraction section. By thus suggesting that the user carry out the first vehicle-based job by using the shared vehicle, utilization of the shared vehicle by the user can be promoted.

### BRIEF DESCRIPTION OF THE DRAWINGS

FIG. 1 is an explanatory diagram of a first mode of provision of vehicle-based job information by a job information provision system;

FIG. 2 is a configuration diagram of the job information provision system;

FIG. 3 is an explanatory diagram of processing for retrieving a first vehicle-based job;

FIG. 4 is a first flowchart of processing for the provision of vehicle-based job information;

FIG. 5 is a second flowchart of the processing for the provision of vehicle-based job information; and

FIG. 6 is an explanatory diagram of a second mode of provision of vehicle-based job information by the job information provision system.

### DETAILED DESCRIPTION OF THE PREFERRED EMBODIMENTS

### 1. First Mode of Provision of Vehicle-Based Job Information

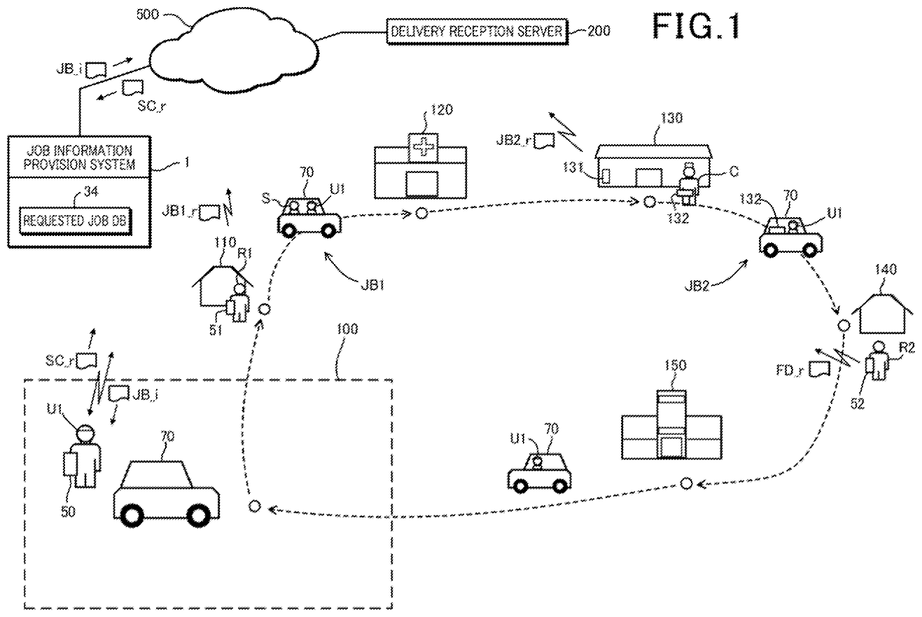

A description will be given, with reference to FIG. 1, of a first mode of provision of vehicle-based job information by a job information provision system 1 according to an embodiment. The job information provision system 1 includes a requested job DB (database) 34 in which information on a request for a vehicle-based job to be carried out by using a vehicle is registered.

FIG. 1 shows a situation in which a user U1 rents a shared vehicle 70 parked in a parking lot 100 by operating a shared vehicle reservation app (application program) that is executed by a user terminal 50 used by the user U1, and moves by driving the shared vehicle 70. The shared vehicle 70 is rented out through a car sharing service that allows shared use of a vehicle among registered members. Note that the shared vehicle 70 may be a vehicle that is rented out through a car rental service that requires no registration for membership.

The user U1 departs from the parking lot 100 and moves to a college 150 that is a destination, and in the course of movement, the user U1 carries out vehicle-based jobs JB1, JB2 by using the shared vehicle 70. Thereafter, the user U1 returns the shared vehicle 70 to the parking lot 100.

The job information provision system 1 receives reservation application information SC_r, transmitted from the user terminal 50, for applying to reserve use of the shared vehicle 70. The job information provision system 1 refers to the requested job D. 34, extracts a vehicle-based job that the user U1 can carry out by using the shared vehicle 70, and transmits vehicle-based job information JB_i including a content of the extracted vehicle-based job to the user terminal 50.

The user U1 checks the vehicle-based job information JB_i received by the user terminal. 50 and considers whether or not to accept the vehicle-based job. The user U1 can receive a fee by accepting and carrying out the vehicle-based job. FIG. 1 shows a situation in which the job information provision system 1 provides information on vehicle-based jobs JB1, JB2 to the user U1, and the user U1 carries out the vehicle-based jobs JB1, JB2.

The vehicle-based job JB1 is a job of giving a requester R1 of the vehicle-based job JB1 a ride in the shared vehicle 70 from a home 110 of the requester R1 to a hospital 120. The requester R1 transmits, to the job information provision system 1, job request information JB1_r for requesting the vehicle-based job JB1, by operating a vehicle-based job request app that is executed by a requester terminal 51 used by the requester R1. The job information provision system 1 that has received the job request information JB1_r registers the job request information including a content of the vehicle-based job JB1 in the requested job DB 34.

The vehicle-based job JB2 is a job of delivering, by carrying in the shared vehicle 70, food and drink 132 provided by an eating and drinking establishment 130 from the eating and drinking establishment 130 to a home 140 of an orderer R2 who has ordered the deliveries. The orderer R2 transmits, to a delivery reception server 200, order information FD_r for requesting delivery of the food and drink 132 to the home 140, by operating a food and drink ordering app that is executed by an orderer terminal 52 used by the orderer R2.

The delivery reception server 200, in response to receipt of the order information FD_r, transmits information for requesting arrangement of the food and drink 132 to a communication terminal 131 of the eating and drinking establishment 130, and hence the food and drink 132 is prepared by the eating and drinking establishment 130. Moreover, the delivery reception server 200 transmits, to the job information provision system 1, job request information JB2_r for requesting agential delivery of the food and drink 132 from the eating and drinking establishment 130 to the home 140 of the orderer R2. The job information provision system 1 that has received the job request information JB2_r registers the job request information including a content of the vehicle-based job JB2 in the requested job DB 34.

The user U1 who has accepted the vehicle-based jobs JB1, JB2 changes a period of reservation of the shared vehicle 70 such that the vehicle-based jobs JB1, JB2 can be carried out. Then, the user U1 rents the shared vehicle 70 at the parking lot 100, goes to the home 110 of the requester R1, and gives the requester R1 a ride in the shared vehicle 70 to the hospital 120. Next, the user U1 moves to the eating and drinking establishment 130, receives the food and drink 132 from a staff member C, and delivers the food and drink 132 to the home 140 of the orderer R2 by carrying in the shared vehicle 70. Thereafter, the user U1 goes to the college 150 that is the destination of the user U1, and, after the user U1 completes some business at the college 150, goes back to the parking lot 100 and returns the shared vehicle 70.

By providing the information on the vehicle-based jobs JB1, JB2 to the user U who has made an application for reservation of the shared vehicle 70, and suggesting that the user U1 accept the vehicle-based jobs using the shared vehicle 70 as described above, further utilization of the shared vehicle 70 by the user U1 can be promoted.

### 2. Configuration of Job Information Provision System

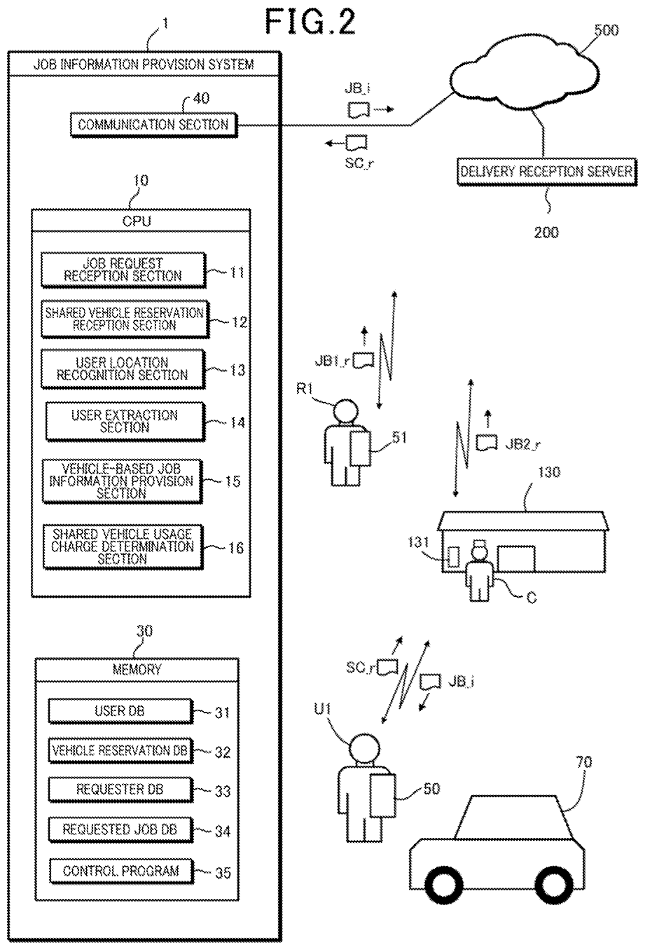

A configuration of the job information provision system 1 will be described with reference to FIG. 2. The same components as the components shown in FIG. 1 are denoted by the same reference signs, and a description thereof is omitted. The job information provision system 1 is a computer system including a CPU (Central Processing Unit) 10, a memory 30, a communication section 40, and the like. The CPU 10 corresponds to a computer in the present invention.

The communication section 40 communicates with the user terminal 50, the communication terminal 131 of the eating and drinking establishment 130, the delivery reception server 200, and the like through a communication network 500. The memory 30 stores the above-described requested job DB 34, and also a user DB 31 in which information on a user who has applied to be registered with the job information provision system 1 in order to use a shared vehicle rental service is recorded, and a vehicle reservation DB 32 in which a reservation status of the shared vehicle is recorded. Moreover, the memory 30 stores a requester DB 33 in which information on a vehicle-based job requester who has applied to be registered with the job information provision system 1 in order to use a vehicle-based job agency service is recorded.

In addition, the memory 30 stores a control program 35 for controlling the job information provision system 1. The CPU 10 functions as a job request reception section 11, a shared vehicle reservation reception section 12, a user location recognition section 13, a user extraction section 14, a vehicle-based job information provision section 15, and a shared vehicle usage charge determination section 16, by reading and executing the control program 35 stored in the memory 30.

Processing performed by the user extraction section 14 corresponds to a user extraction step in a job information provision method of the present invention. Processing performed by the vehicle-based job information provision section 15 corresponds to a vehicle-based job information provision step in the job information provision method of the present invention.

The job request reception section 11 receives job request information transmitted from a requester who requests a vehicle-based job, accepts the request for the vehicle-based job, and records the job request information including a content of the accepted vehicle-based job in the requested job DB 34. The job request information includes, as the requested content of the vehicle-based job, a type of the job (pickup and drop-off by using a vehicle, delivery by using a vehicle, collecting an article by using a vehicle, or the like), a desired date and time of carrying out the job, an amount of a fee for carrying out the job, and the like. For the job request information, FIG. 1 illustrates the job request information JB1_r for requesting the vehicle-based job JB1 (pickup and drop-off by using a vehicle), and the job request information JB2_r for requesting the vehicle-based job JB2 (delivery of food and drink by using a vehicle).

The shared vehicle reservation reception section 12 receives reservation application information SC_r, transmitted from the user terminal 50, for applying to reserve the shared vehicle 70, and accepts the reservation for use of the shared vehicle 70. The shared vehicle reservation reception section 12 records, in the vehicle reservation DB 32, vehicle reservation information including a content of the reservation (specification of a period of use, a place of return, and the like) of the shared vehicle 70 specified by the reservation application information SC_r.

The user location recognition section 13 recognizes a current location of the user terminal 50 as a current location of the user U1, by receiving current location information of the user terminal 50 transmitted from the user terminal 50. The user terminal 50 includes a GPS (Global Positioning System) sensor (not shown), and transmits the current location information including the current location of the user terminal 50 sensed by the GPS sensor to the job information provision system 1.

The user extraction section 14 extracts a user who has made an application for reservation of the shared vehicle. A fact that a user has made an application for reservation of a shared vehicle corresponds to an extraction condition in the present invention. In the example in FIGS. 1 and 2, the user U1 whose application for reservation of the shared vehicle 70 is accepted by the shared vehicle reservation reception section 12 is extracted by the user extraction section 14.

When the user U1 who has made the application for reservation of the shared vehicle 70 is extracted by the user extraction section 14, the vehicle-based job information provision section 15 refers to the job request information registered in the requested job DB 34 and extracts, as a first vehicle-based job, a vehicle-based job that applies to any one of following first to third matching conditions.

First matching condition: A desired timing of carrying out the vehicle-based job falls within the period of reservation of the shared vehicle 70.

Second matching condition: A desired timing of carrying out the vehicle-based job falls within a range between a first predetermined time period before a beginning time point of the period of reservation of the shared vehicle 70 and the beginning time point.

Third matching condition: A desired timing of carrying out the vehicle-based job falls within a range between an ending time point of the period of reservation of the shared vehicle 70 and a second predetermined time period after the ending time point.

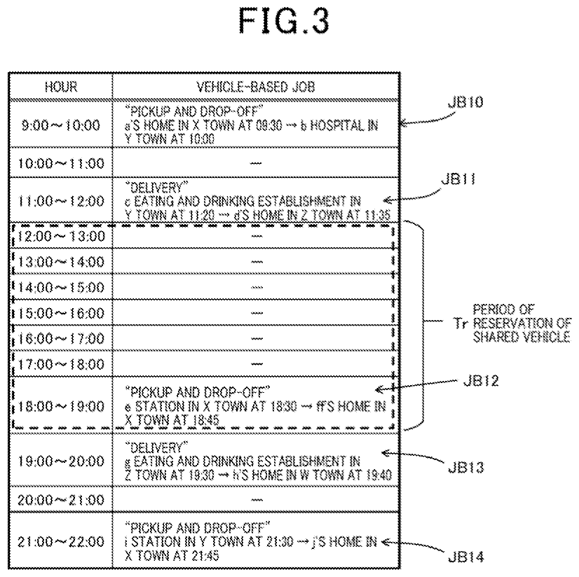

The vehicle-based job information provision section 15 transmits, to the user terminal 50, first vehicle-based job information JB_i including a content of the extracted first vehicle-based job. Here, FIG. 3 illustrates an aspect of extracting the first vehicle-based job, depending on the period of reservation of the shared vehicle 70.

FIG. 3 shows a state of vehicle-based jobs on which job request information is registered in the requested job DB 34, between 09:00 and 22:00 on a date for which the shared vehicle 70 is reserved. Tr (12:00 to 19:00) in FIG. 3 is the period of reservation of the shared vehicle 70 reserved by the user U1. In FIG. 3, a vehicle-based job JB1 of “pickup and drop-off” is registered in a time slot between 09:00 and 10:00, a vehicle-based job JB11 of “delivery” is registered in a time slot between 11:00 and 12:00, and a vehicle-based job JB12 of “pickup and drop-off” is registered in a time slot between 18:00 and 19:00.

Further, a vehicle-based job JB13 of “delivery” is registered in a time slot between 19:00 and 20:00, and a vehicle-based job JB14 of “pickup and drop-off” is registered in a time slot between 21:00 and 22:00. When the first predetermined time period and the second predetermined time period mentioned above are each set to one hour, the vehicle-based job information provision section 15 extracts the vehicle-based job JB12 that meets the first matching condition, the vehicle-based job JB11 that meets the second matching condition, and the vehicle-based job JB13 that meets the third matching condition, as the first vehicle-based jobs.

The vehicle-based job information provision section 15 transmits the first vehicle-based job information JB_i including contents of the extracted vehicle-based jobs JB11, JB12, JB13 to the user terminal. 50. The user U1 checks the first vehicle-based job information JB_i received by the user terminal 50 and, when the user U1 desires to accept any first vehicle-based job, transmits acceptance application information to the job information provision system 1.

When the acceptance application information is received, the vehicle-based job information provision section 15 retrieves a second vehicle-based job that has a predetermined relation with the accepted first vehicle-based job. Here, as the predetermined relation, a fact that a desired timing of carrying out a job is different from a timing of carrying out the first vehicle-based job is set. In the example in FIG. 3, for example, when JB12 among the first vehicle-based jobs JB11, JB12, JB13 is accepted, the vehicle-based job information provision section 15 extracts JB11, JB13 as the second vehicle-based jobs and transmits information on JB11, JB13 to the user terminal 50. By thus suggesting that the user U1 accept the additional vehicle-based jobs, further utilization of the shared vehicle 70 can be promoted.

Note that as the predetermined relation, another fact may be set, such as that a job is carried out at or within a predetermined distance from a place where the first vehicle-based job accepted by the user U1 is carried out, or that a job is carried out within a predetermined time period before or after the timing of carrying out the first vehicle-based job accepted by the user U1.

When the user U1 has accepted a vehicle-based job and has carried out the vehicle-based job, the shared vehicle usage charge determination section 16 determines a usage charge for the shared vehicle 70 to be claimed against the user U1, based on a fee for carrying out the vehicle-based job and a preset basic usage charge for the shared vehicle 70.

In other words, the shared vehicle usage charge determination section 16 determines a usage charge, according to a following formula (1):

Schg=Bchg−JBr (1)

where Schg is the usage charge for the shared vehicle, Bchg is the basic usage charge for the shared vehicle, and JBr is a fee for carrying out the vehicle-based job.

When the fee JBr for carrying out the vehicle-based job is an equal amount to the basic usage charge Bchg for the shared vehicle 70, the usage charge Schg for the shared vehicle 70 is free, according to the formula (1). When the fee JBr for carrying out the vehicle-based job exceeds the basic usage charge Bchg for the shared vehicle 70, the usage charge for the shared vehicle 70 is free, and a surplus fee is paid to the user U1.

By thus determining the usage charge for the shared vehicle 70, the user U1 is given an incentive to accept a vehicle-based job using the shared vehicle 70 to reduce the usage charge for the shared vehicle 70. Thus, utilization of the shared vehicle by the user U1 can be further promoted.

### 3. Processing for Provision of Vehicle-Based Job Information

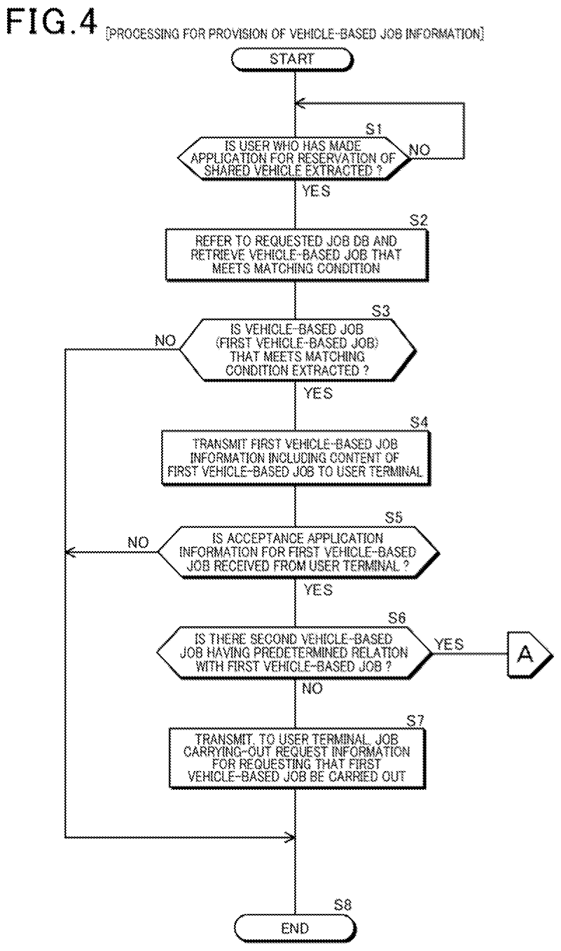

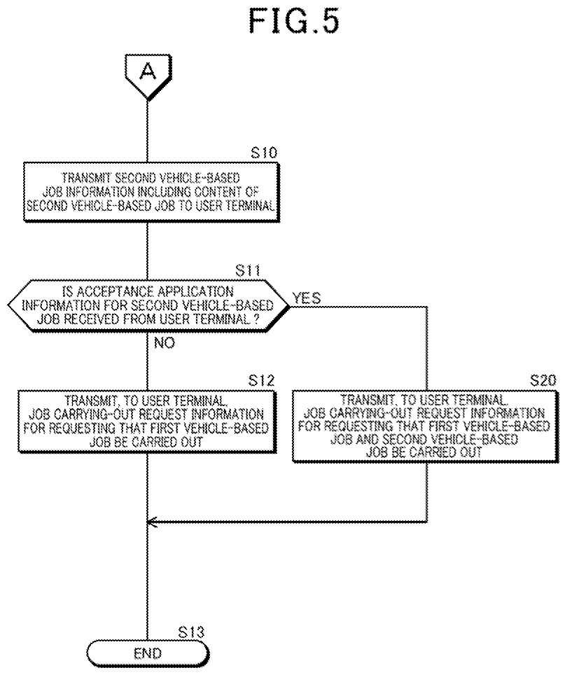

A description will be given, by following flowcharts shown in FIGS. 4 and 5, of a series of processing for the provision of vehicle-based job information, which is performed by the vehicle-based job information provision section 15 when the user U1 has reserved the shared vehicle 70 as described above with reference to FIGS. 1 and 2.

In step S1 in FIG. 4, when the user U1 who has made an application for reservation of the shared vehicle 70 is extracted by the user extraction section 14, the vehicle-based job information provision section 15 advances the processing to step S2. In step S2, the vehicle-based job information provision section 15 refers to the requested job DB 34 and retrieves a vehicle-based job that meets any one of the above-described first to third matching conditions.

In subsequent step S3, when a vehicle-based job that meets any one of the first to third matching conditions is extracted, the vehicle-based job information provision section 15 advances the processing to step S4. When no vehicle-based job that meets any one of the first to third matching conditions is extracted, the vehicle-based job information provision section 15 advances the processing to step S8, in which case the provision of vehicle-based job information to the user U1 is not performed.

In step S4, the vehicle-based job information provision section 15 transmits, to the user terminal 50, first vehicle-based job information JB_i including a content of the extracted vehicle-based job (first vehicle-based job). In subsequent step S5, the vehicle-based job information provision section 15 advances the processing to step S6 when acceptance application information, transmitted from the user terminal 50, for applying to accept the first vehicle-based job is received, and advances the processing to step S8 when such acceptance application information is not received.

Here, if a plurality of vehicle-based jobs that meet any of the first to third matching conditions are extracted, the vehicle-based job information provision section 15 transmits information on the plurality of first vehicle-based jobs to the user terminal 50. In such a case, the user U1 can accept the plurality of first vehicle-based jobs.

In step S6, the vehicle-based job information provision section 15 determines whether or not there is any second vehicle-based job that has a predetermined relation with the first vehicle-based job accepted by the user U1, among the vehicle-based jobs extracted in step S2 that meet any of the first to third matching conditions. Here, in the present embodiment, the fact that a desired timing of carrying out a job is different from the timing of carrying out the accepted first vehicle-based job is set as the predetermined relation, as described above.

The vehicle-based job information provision section 15 advances the processing to step S10 in FIG. 5 when there is a second vehicle-based job that has the predetermined relation with the first vehicle-based job, and advances the processing to step S7 when there is no second vehicle-based job that has the predetermined relation with the first vehicle-based job. In step S7, the vehicle-based job information provision section 15 transmits, to the user terminal 50, job carrying-out request information for requesting that the first vehicle-based job be carried out.

In step 310 in FIG. 5, the vehicle-based job information provision section 15 transmits, to the user terminal 50, second vehicle-based job information including a content of the second vehicle-based job. In subsequent step S11, the vehicle-based job information provision section 15 advances the processing to step S20 when acceptance application information, transmitted from the user terminal 50, for applying to accept the second vehicle-based job is received, and advances the processing to step S12 when such acceptance application information is not received.

In step S12, the vehicle-based job information provision section 15 transmits, to the user terminal 50, job carrying-out request information for requesting that the first vehicle-based job be carried out. In step S20, the vehicle-based job information provision section 15 transmits, to the user terminal 50, job carrying-out request information for requesting that the first vehicle-based job and the second vehicle-based job be carried out.

### 4. Second Mode of Provision of Vehicle-Based Job Information

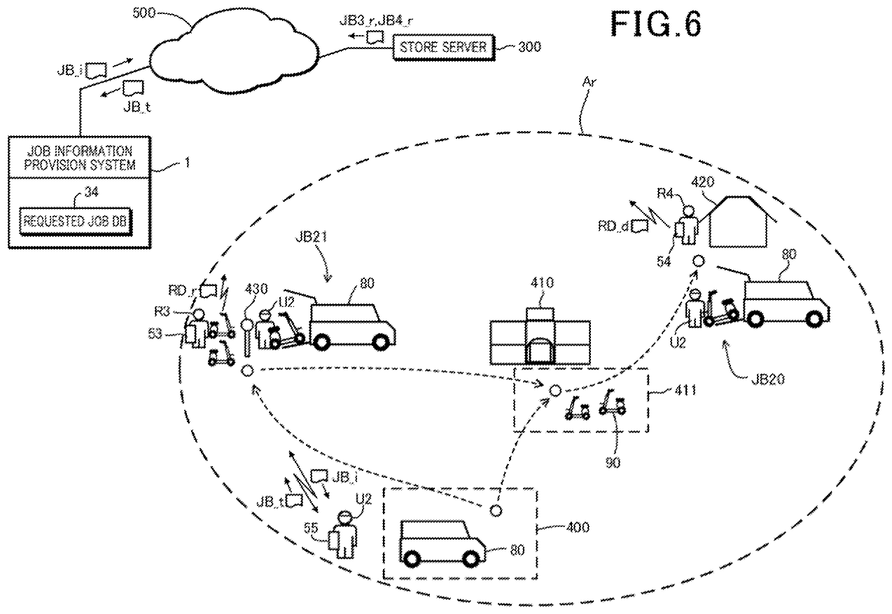

A description will be given, with reference to FIG. 6, of a second mode of provision of vehicle-based job information by the job information provision system 1. In the above-described first mode, the job information provision system 1 provides information on a vehicle-based job to the user U1 who has made an application for reservation of the shared vehicle 70. In contrast, in the second mode, the job information provision system 1 provides information on a vehicle-based job to a user U2 located near a parking lot 400 that is a point where a shared vehicle 80 is rented out.

FIG. 6 shows a situation in which, within an area Ar around a shopping mall 410, vehicle-mountable electric scooters 90 are lent to consumers R3, R4 who use the shopping mall 410, as moving means used when a consumer goes to the shopping mall 410, or as moving means used when a consumer goes home from the shopping mall 410. The area Ar is set, for example, within a 2-kilometer radius of the shopping mall 410.

Lending of the electric scooter 90 is performed in two lending forms as described below.

First lending form: An electric scooter 90 is delivered in response to a request from the consumer R4 who will visit the shopping mall 410, from a parking space 411 of the shopping mall 410 to a home 420 of the consumer R4. The consumer R4 arranges the delivery of the electric scooter 90, by transmitting, to a store server 300 operated by the shopping mall. 410, delivery request information RD_d for requesting delivery of an electric scooter 90 by operating a consumer app of the shopping mall 410 that is executed by a consumer terminal 54 used by the consumer R4. The consumer R4 goes to the shopping mall 410 by driving the delivered electric scooter 90.

Second lending form: An electric scooter 90 is lent to the consumer R3 who has visited the shopping mall 410, for the consumer R3 to go home. In such a case, the consumer R3 may move to the home by the electric scooter 90, or may move to any one of return spots 430 set at various places in the area Ar and leave the electric scooter 90 behind. The consumer R3 transmits, to the store server 300, return notification information RD_r for notifying that the electric scooter 90 is returned, by operating the consumer app of the shopping mail 410 that is executed by a consumer terminal 53 used by the consumer R3, or by operating a return button (not shown) provided on the electric scooter 90.

When the delivery request information RD_d is received, the store server 300 transmits, to the job information provision system 1, job request information JB3_r for requesting a vehicle-based job JB20 of delivering an electric scooter 90 from the parking space 411 of the shopping mall 410 to the home 420 of the consumer R4. When the return notification information RD_r is received, the store server 300 transmits, to the job information provision system 1, job request information JB4_r for requesting a vehicle-based job JB21 of collecting an electric scooter 90 notified to be returned, loading the electric scooter 90 into the shared vehicle 80, and carrying the electric scooter 90 to the parking space 411 of the shopping mall 410.

The job request reception section 11 records the job request information JB20, JB21 in the requested job DB 34. When a distance between a current location of the user U2 recognized by the user location recognition section 13 and the parking lot 400, which is the point where the shared vehicle 80 is rented out, is equal to or shorter than a first predetermined distance, the user extraction section 14 extracts the user U2 as a target to which vehicle-based job information is provided. Then, the vehicle-based job information provision section 15 refers to the requested job DB 34, extracts, for example, a vehicle-based job that is carried out at or within a second predetermined distance from the parking lot. 400, which is the point where the shared vehicle 80 is rented out, as a first vehicle-based job, and transmits first vehicle-based job information JB_i including a content of the first vehicle-based job to a user terminal 55.

In the example in FIG. 6, the vehicle-based job JB20 of delivering an electric scooter 90 by using the shared vehicle 80, and the vehicle-based job JB21 of collecting an electric scooter 90 by using the shared vehicle 80 are extracted as the first vehicle-based jobs. Then, information on the vehicle-based jobs JB20, JB21 is transmitted to the user terminal 55.

The user U2 checks requested contents of the vehicle-based jobs JB20, JB21 by using the user terminal 55 and, when accepting the vehicle-based job JB20 or JB21, applies to reserve the shared vehicle 80 and to accept the vehicle-based job JB20 or JB21. The user U2 can obtain a fee by carrying out the vehicle-based job JB20 or JB21 by using the shared vehicle 80. Thus, utilization of the shared vehicle 80 by the user U2 can be promoted.

Moreover, as in the first mode, when the user U2 seeks to accept any one first vehicle-based job, second vehicle-based job information including a content of a second vehicle-based job that has a predetermined relation with the first vehicle-based job may be transmitted to the user terminal 55.

### 5. Other Embodiments

In the above-described embodiment, the job information provision system 1 includes the shared vehicle reservation reception section 12, and the shared vehicle reservation reception section 12 acquires reservation application information SC_r on the shared vehicle by receiving the reservation application information SC_r transmitted from the user terminal 50. As another configuration, the job information provision system 1 may include, in place of the shared vehicle reservation reception section 12, a reservation application information acquisition section that does not have a function of receiving a reservation of the shared vehicle. In such a case, a configuration is made such that reception of a reservation of the shared vehicle is performed by a reservation reception system that is different from the job information provision system 1, and reservation application information SC_r on the shared vehicle is transferred from the reservation reception system to the job information provision system 1, whereby the reservation application information acquisition section acquires the reservation application information SC_r on the shared vehicle.

In the above-described embodiment, the vehicle-based job information provision section 15 extracts, by using the first to third matching conditions, a first vehicle-based job or first vehicle-based jobs from among vehicle-based jobs with requested contents registered in the requested job DB 34. As another embodiment, a first vehicle-based job or first vehicle-based jobs may be extracted by using only any one, or any two, of the first to third matching conditions. Alternatively, the vehicle-based job information provision section 15 may extract a first vehicle-based job or first vehicle-based jobs by using a matching condition other than the first to third matching conditions.

In the above-described embodiment, the vehicle-based job information provision section 15 transmits information on a second vehicle-based job that has the predetermined relation with a first vehicle-based job to the user terminal 50. As another embodiment, a configuration may be made such that the information on the second vehicle-based job is not transmitted.

In the above-described embodiment, the user extraction section 14 uses, as the extraction conditions for extracting a user to which information on a vehicle-based job is provided, the fact that a user has made an application for reservation of the shared vehicle, and the fact that a user is located at or within the predetermined distance from the point where the shared vehicle is rented out. However, another extraction condition may be used. For example, a fact that a user has checked availability of the shared vehicle, or the like may be used as a condition for extracting a user.

As another condition for extracting a user, a fact that a user has an available time period in a schedule may be used. The fact that a user has an available time period in a schedule can be recognized, for example, by referring to schedule information that is updated as needed by a schedule app used by the user and is stored in a user terminal used by the user or in a schedule server.

In the above-described embodiment, the vehicle-based job information provision section 15 transmits the first vehicle-based job information to the user terminal 50, 51 before the user U1, U2 starts using the shared vehicle 70, 80. As another embodiment, information on a vehicle-based job may be transmitted to the user terminal while the user is using the shared vehicle. According to such an embodiment, the user can obtain a fee by accepting and carrying out a vehicle-based job by using the shared vehicle, for example, when the user has spare time during use of the shared vehicle.

Note that FIG. 2 is a schematic diagram in which the functional components of the job information provision system 1 are shown by being sectionalized based on main processing contents, to facilitate understanding of the invention of the present application, and components of the job information provision system 1 may be configured based on other categories. The processing by each constituent element may be performed by a single hardware unit, or may be performed by a plurality of hardware units. The processing by each constituent element shown in FIGS. 4 and 5 may be performed by using a single program, or may be performed by using a plurality of programs.

### 6. Configurations Supported by the Above-Described Embodiments

The above-described embodiments are specific examples of configurations described below.

(First item) A job information provision system, including: a user extraction section that extracts a user who meets a predetermined extraction condition; and a vehicle-based job information provision section that transmits, to a user terminal used by the user extracted by the user extraction section, first vehicle-based job information including a content of a first vehicle-based job that is a job the user can carry out by using a shared vehicle.

According to the job information provision system of the first item, the first vehicle-based job information including the content of the first vehicle-based job that is a job the user can carry out by using the shared vehicle is transmitted, by the vehicle-based job provision section, to the user terminal used by the user who has made an application for reservation of the shared vehicle. By thus suggesting that the user carry out the first vehicle-based job by using the shared vehicle, utilization of the shared vehicle by the user car be promoted.

(Second item) The job information provision system set forth in the first item, wherein the user extraction section uses, for the extraction condition, a fact that the user has made an application for reservation of the shared vehicle.

According to the job information provision system of the second item, the user who has made the application for reservation of the shared vehicle can be encouraged to carry out the first vehicle-based job utilizing the shared vehicle.

(Third item) The job information provision system set forth in the second item, wherein the vehicle-based job information provision section transmits the first vehicle-based job information to the user terminal, by referring to a requested job database in which job request information including a requested content of each vehicle-based job to be carried out by using a vehicle is registered, and extracting, as the first vehicle-based job, a vehicle-based job with the requested content that meets a predetermined matching condition for matching with a content of the reservation of the shared vehicle specified by the application for reservation, among the vehicle-based jobs on which the job request information is registered in the requested job database.

According to the job information provision system of the third item, by extracting, as the first vehicle-based job, the vehicle-based job with the requested content that meets the predetermined matching condition for matching with the content of the reservation of the shared vehicle, information on the first vehicle-based job that matches with a state of use of the shared vehicle can be provided to the user.

(Fourth item) The job information provision system set forth in the third item, wherein the vehicle-based job information provision section uses, for the matching condition, a fact that a desired timing of carrying out the vehicle-based job specified by the job request information falls within any one of: a period of reservation of the shared vehicle specified by the application for reservation; a range between a first predetermined time period before a beginning time point of the period of reservation and the beginning time point; and a range between an ending time point of the period of reservation and a second predetermined time period after the ending time point.

According to the job information provision system of the fourth item, information on the first vehicle-based job that can be carried out efficiently according to a time period for which the user plans to use the shared vehicle can be provided to the user.

(Fifth item) The job information provision system set forth in any one of the first to fourth items, wherein the user extraction section uses, for the extraction condition, a fact that a point where the user is located is at or within a predetermined distance from a point where the shared vehicle is rented out.

According to the job information provision system of the fifth item, information on the first vehicle-based job can be provided to the user who is located near the point where the shared vehicle is rented out and so can easily use the shared vehicle.

(Sixth item) The job information provision system set forth in any one of the first to fifth items, wherein when first vehicle-based job acceptance information for seeking to accept the first vehicle-based job is received from the user terminal, the vehicle-based job information provision section transmits, to the user terminal, second vehicle-based job information including a content of a second vehicle-based job to be carried out by using the shared vehicle, the second vehicle-based job having a predetermined relation with the first vehicle-based job.

According to the job information provision system of the sixth item, by providing information on the second vehicle-based job to the user in addition to the first vehicle-based job, further utilization of the shared vehicle by carrying out the second vehicle-based job can be promoted.

(Seventh item) The job information provision system set forth in any one of the first to sixth items, further including a shared vehicle usage charge determination section that, when the user has carried out the first vehicle-based job, determines a usage charge for the shared vehicle to be claimed against the user, by making a discount off a basic usage charge for the shared vehicle, the discount being made according to an amount of a fee for the first vehicle-based job.

According to the job information provision system of the seventh item, by providing an incentive for the user to carry out the first vehicle-based job, the incentive reducing the usage charge for the shared vehicle, the user can be encouraged to carry out the first vehicle-based job.

(Eighth item) The job information provision system set forth in any one of the first to seventh items, wherein the first vehicle-based job includes delivery or collection, by using the shared vehicle, of vehicle-mountable moving means.

According to the job information provision system of the eighth item, delivery or collection of the vehicle-mountable moving means such as a scooter for the elderly, which is expected to be widely used in the future, can be extracted as the first vehicle-based job by the vehicle-based job information provision section.

(Ninth item) The job information provision system set forth in any one of the first to eighth items, wherein the first vehicle-based job includes agential delivery of a predetermined article from a provider to an orderer.

According to the job information provision system of the ninth item, agential delivery of a predetermined article, the agential delivery supposed to be much in demand among vehicle-based jobs, can be extracted as the first vehicle-based job by the vehicle-based job information provision section.

(Tenth item) A job information provision method executed by a computer, including: a user extraction step of extracting a user who meets a predetermined extraction condition; and a vehicle-based job information provision step of transmitting, to a user terminal used by the user extracted in the user extraction step, first vehicle-based job information including a content of a first vehicle-based job that is a job the user can carry out by using a shared vehicle.

By causing the computer to execute the job information provision method of the tenth item, the components of the job information provision system of the first item can be implemented.

### REFERENCE SIGNS LIST

1 . . . job information provision system, 10 . . . CPU, 11 . . . job request reception section, 12 . . . shared vehicle reservation reception section, 13 . . . user location recognition section, 14 . . . user extraction section, 15 . . . vehicle-based job information provision section, 16 . . . shared vehicle usage charge determination section, 30 . . . memory, 31 . . . user DB, 32 . . . vehicle reservation DB, 33 . . . requester DB, 34 . . . requested job DB, 35 . . . control program, 50 . . . user terminal, 51, 52 . . . requester terminal, 53, 54 . . . consumer terminal, 70, 80 . . . shared vehicle, 90 . . . electric scooter, 200 . . . delivery reception server, 300 . . . store server, U1, U2 . . . user.

What is claimed is:

1. A job information provision system, comprising:
a user extraction section that extracts a user who meets a predetermined extraction condition; and
a vehicle-based job information provision section that transmits, to a user terminal used by the user extracted by the user extraction section, first vehicle-based job information including a content of a first vehicle-based job that is a job the user can carry out by using a shared vehicle.

2. The job information provision system according to claim 1, wherein the user extraction section uses, for the extraction condition, a fact that the user has made an application for reservation of the shared vehicle.

3. The job information provision system according to claim 2, wherein the vehicle-based job information provision section transmits the first vehicle-based job information to the user terminal, by referring to a requested job database in which job request information including a requested content of each vehicle-based job to be carried out by using a vehicle is registered, and extracting, as the first vehicle-based job, a vehicle-based job with the requested content that meets a predetermined matching condition for matching with a content of the reservation of the shared vehicle specified by the application for reservation, among the vehicle-based jobs on which the job request information is registered in the requested job database.

4. The job information provision system according to claim 3, wherein the vehicle-based job information provision section uses, for the matching condition, a fact that a desired timing of carrying out the vehicle-based job specified by the job request information falls within any one of: a period of reservation of the shared vehicle specified by the application for reservation; a range between a first predetermined time period before a beginning time point of the period of reservation and the beginning time point; and a range between an ending time point of the period of reservation and a second predetermined time period after the ending time point.

5. The job information provision system according to claim 1, wherein the user extraction section uses, for the extraction condition, a fact that a point where the user is located is at or within a predetermined distance from a point where the shared vehicle is rented out.

6. The job information provision system according to claim 1, wherein when first vehicle-based job acceptance information for seeking to accept the first vehicle-based job is received from the user terminal, the vehicle-based job information provision section transmits, to the user terminal, second vehicle-based job information including a content of a second vehicle-based job to be carried out by using the shared vehicle, the second vehicle-based job having a predetermined relation with the first vehicle-based job.

7. The job information provision system according to claim 1, further comprising a shared vehicle usage charge determination section that, when the user has carried out the first vehicle-based job, determines a usage charge for the shared vehicle to be claimed against the user, by making a discount off a basic usage charge for the shared vehicle, the discount being made according to an amount of a fee for the first vehicle-based job.

8. The job information provision system according to claim 1, wherein the first vehicle-based job includes delivery or collection, by using the shared vehicle, of vehicle-mountable moving means.

9. The job information provision system according to claim 1, wherein the first vehicle-based job includes agential delivery of a predetermined article from a provider to an orderer.

10. A job information provision method executed by a computer, comprising:
a user extraction step of extracting a user who meets a predetermined extraction condition; and
a vehicle-based job information provision step of transmitting, to a user terminal used by the user extracted in the user extraction step, first vehicle-based job information including a content of a first vehicle-based job that is a job the user can carry out by using a shared vehicle.
